(19) United States
(12) Patent Application Publication
(10) Pub. No.: US 2021/0295370 A1
(43) Pub. Date: Sep. 23, 2021

(54) INFORMATION PROCESSING DEVICE AND INFORMATION PROCESSING METHOD

(71) Applicant: TOSHIBA TEC KABUSHIKI KAISHA, Tokyo (JP)

(72) Inventor: Ryotaro KOBAYASHI, Izunokuni (JP)

(73) Assignee: TOSHIBA TEC KABUSHIKI KAISHA, Tokyo (JP)

(21) Appl. No.: 17/177,474

(22) Filed: Feb. 17, 2021

(30) Foreign Application Priority Data
Mar. 17, 2020 (JP) 2020-046112

(51) Int. Cl. G06Q 30/02

(52) U.S. Cl. CPC G06Q 30/0236; G06Q 30/0239; G06Q 30/0238; G06Q 30/0224

(57) ABSTRACT

An information processing device includes a processor. The processor is configured to acquire a commodity purchase history of a user and first commodity registration information indicating a first purchase registration of a first commodity, determine discount information regarding a second commodity to which a discount can be applied in combination with the first commodity based on the commodity purchase history, and output discount information regarding the second commodity.

### CROSS-REFERENCE TO RELATED APPLICATION

This application is based upon and claims the benefit of priority from Japanese Patent Application No. 2020-046112, filed on Mar. 17, 2020, the entire contents of which are incorporated herein by reference.

### FIELD

Embodiments described herein relate generally to an information processing device and an information processing method.

### BACKGROUND

In recent years, various information processing systems that promote sales by supplying information for stimulating purchasers to purchase commodities during shopping in stores have been proposed. In such information processing systems, discount information regarding commodities set in advance uniformly in combination is supplied. Staffs in charge of sales promotion select commodities in advance in combination and change combinations of commodities as necessary.

### DESCRIPTION OF THE DRAWINGS

FIG. 1 is a schematic diagram illustrating a schematic configuration of an information processing system according to an embodiment;

FIG. 2 is a block diagram illustrating a circuit configuration of a mobile terminal;

FIG. 3 is a perspective view illustrating an example of a shopping cart provided with the mobile terminal;

FIG. 4 is a block diagram illustrating a circuit configuration of a discount server;

FIG. 5 is a schematic diagram illustrating an example of a discount table;

FIG. 6 is a block diagram illustrating a circuit configuration of a virtual point of sale (POS) server;

FIG. 7 is a schematic diagram illustrating an example of a purchase registration list;

FIG. 8 is a block diagram illustrating a circuit configuration of an accounting machine;

FIG. 9 is a flowchart illustrating a control procedure of a processor in the mobile terminal;

FIG. 10 is a flowchart illustrating a control procedure of the processor in the mobile terminal;

FIG. 11 is a flowchart illustrating a control procedure of the processor in the mobile terminal;

FIG. 12 is a flowchart illustrating a control procedure of the processor in the mobile terminal;

FIG. 13 is a flowchart illustrating a control procedure of the processor in the discount server;

FIG. 14 is a flowchart illustrating a control procedure of the processor in the discount server;

FIG. 15 is a flowchart illustrating a control procedure of the processor in the discount server;

FIG. 16 is a flowchart illustrating a control procedure of the processor in the discount server;

FIG. 17 is a flowchart illustrating a control procedure of the processor in the discount server;

FIG. 18 is a flowchart illustrating a control procedure of the processor in the discount server;

FIG. 19 is a flowchart illustrating a control procedure of the processor in the accounting machine;

FIG. 20 is a flowchart illustrating a control procedure of the processor in the virtual POS server;

FIG. 21 is a schematic diagram illustrating an example of a purchase registration screen displayed on the mobile terminal;

FIG. 22 is a schematic diagram illustrating an example of a discount information image displayed on the mobile terminal;

FIG. 23 is a schematic diagram illustrating an example of a discount cancellation information image displayed on the mobile terminal; and

FIG. 24 is a schematic diagram illustrating an example of a purchase registration screen updated after purchase cancellation and displayed on the mobile terminal.

### DETAILED DESCRIPTION

The discount information is uniform. Therefore, because of a lack of impact, there are requests for structures of more effective sales promotion despite being uniform.

In general, an exemplary embodiment provides an information processing device and an information processing method capable of supplying more effective discount information.

According to one embodiment, an information processing device includes an acquisition unit, a selection unit, and an output unit. The acquisition unit acquires a commodity purchase history and first commodity registration information indicating a purchase schedule of a first commodity. The selection unit selects discount information regarding a second commodity to which discount is applied in combination with the first commodity based on the commodity purchase history. The output unit outputs discount information regarding the second commodity.

Hereinafter, an embodiment will be described with reference to the drawings. In the embodiment, a tablet terminal fitted on a shopping cart (a so-called cart terminal) is used as a mobile terminal.

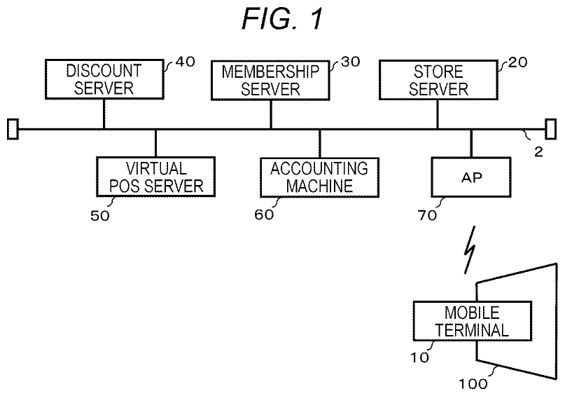

FIG. 1 is a schematic diagram illustrating a schematic configuration of an information processing system 1 according to an embodiment.

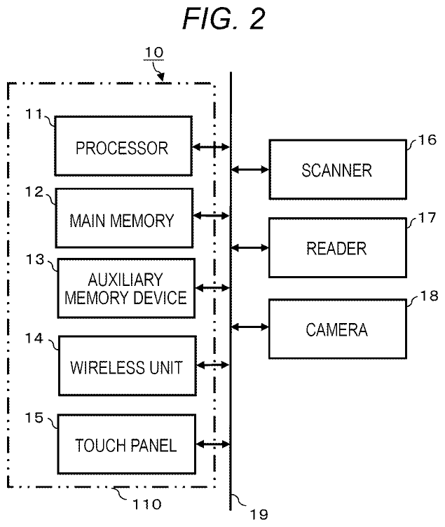

The information processing system 1 includes a mobile terminal 10, a store server 20, a membership server 30, a discount server 40, a virtual point POS server 50, an accounting machine 60, and an access point 70. The store server 20, the membership server 30, the discount server 40, the virtual POS server 50, the accounting machine 60, and the access point 70 are connected to a network 2 such as a local area network (LAN). The mobile terminal 10 includes a wireless unit 14 (see FIG. 2). The mobile terminal 10 executes wireless communication with the access point 70. The access point 70 relays communication of each device connected to the network 2, that is, the server 20, the membership server 30, the discount server 40, the virtual POS server 50, and the accounting machine 60. Only one access point 70 is illustrated in FIG. 1, but two or more access points may be provided depending on a scale or the like of a store.

The mobile terminal 10 is a device that enables users to input data related to registration of commodities which the users will purchase by themselves. The mobile terminal 10 is provided on a shopping cart 100. Hereinafter, the shopping cart 100 is simply referred to as the cart 100. Each mobile terminal 10 is provided on each of the plurality of carts 100. The cart 100 is an example of a carrier used to carry purchase commodities of a user who is using the cart 100.

The store server 20 manages a commodity database. The commodity database stores a commodity data record in which data of commodities sold in a store are described. The commodity data record includes items such as a commodity code, a commodity name, a unit price, and a discount commodity code. The commodity code is commodity identification data set on a per commodity basis to identify an individual commodity. The unit price is a price per commodity. The discount commodity code is a commodity code of a commodity to which discount is applied, that is, a so-called discount commodity, by combining a purchase commodity when a commodity with a commodity code included in the same commodity data record as the discount commodity code is purchased. Furthermore, some discount commodities may not be combined with commodities. In this case, a null value is set as the discount commodity code.

The membership server 30 manages a membership database. The membership database stores a membership data record in which membership data is described for each member. The membership data record includes items such as a membership ID, a name, a sex, a mail address, and a commodity purchase history data. The membership ID is an identification code of a member. The commodity purchase history data is data indicating a commodity purchase history that shows where and which commodities a member having a membership identified with the membership ID purchases.

The discount server 40 manages a discount database 431. The discount database 431 stores a discount data record in which discount data is described. The discount data record includes items such as a discount ID and discount information. The discount ID is an identification code set for each piece of information to identify individual discount information. The discount information includes discount content, a discount amount, and a sales price. The discount content is content of discount privilege applied when another commodity is purchased in combination of a purchase commodity. The discount amount is a price of a commodity to which discount is applied. The sales price is a price of a commodity before discount is applied. Normally, the discount amount is cheaper than the sales price.

The virtual POS server 50 causes the mobile terminal 10 to operate such that a function of a POS terminal is realized in cooperation with the mobile terminal 10.

The accounting machine 60 is a device that enables a store staff or a user to execute accounting of a purchase commodity. The number of accounting machines 60 is not particularly limited.

FIG. 2 is a block diagram illustrating a circuit configuration of main units of a mobile terminal 10. The mobile terminal 10 includes a processor 11, a main memory 12, an auxiliary memory device 13, a wireless unit 14 (a wireless transceiver, a wireless communications interface), a touch panel 15 (a display, a user interface), a scanner 16, a reader 17, a camera 18, and a system transmission path 19. The system transmission path 19 includes an address bus, a data bus, and a control signal line. In the mobile terminal 10, the processor 11, the main memory 12, the auxiliary memory device 13, the wireless unit 14, the touch panel 15, the scanner 16, the reader 17, and the camera 18 are connected to the system transmission path 19. In the mobile terminal 10, the processor 11, the main memory 12, and the auxiliary memory device 13, and the system transmission path 19 connecting them to configure a computer.

The processor 11 corresponds to a central unit of the computer. The processor 11 controls each unit such that various functions of the mobile terminal 10 can be realized in accordance with an operating system or an application program. The processor 11 is, for example, a central processing unit (CPU).

The main memory 12 corresponds to a main memory unit of the computer. The main memory 12 includes a nonvolatile memory area and a volatile memory area. The main memory 12 stores the operating system or the application program in the nonvolatile memory area. The main memory 12 stores data necessary for the processor 11 to execute a process of controlling each unit in the nonvolatile memory area or the volatile memory area. In the main memory 12, the volatile memory area is used as a work area in which data can be rewritten appropriately by the processor 11. The nonvolatile memory area is, for example, a read-only memory (ROM). The volatile memory area is, for example, a random access memory (RAM).

The auxiliary memory device 13 corresponds to an auxiliary memory unit of the computer. For example, an electric erasable programmable read-only memory (EEPROM), a hard disc drive (HDD), a solid-state drive (SSD), or the like can be used as the auxiliary memory device 13. The auxiliary memory device 13 stores data that is used for the processor 11 to execute various processes, data which is generated through a process by the processor 11, and the like. The auxiliary memory device 13 stores the foregoing application program in some cases.

The application program stored in the main memory 12 or the auxiliary memory device 13 includes a control program in which information processing executed by the mobile terminal 10 is described. A method of installing the control program in the main memory 12 or the auxiliary memory device 13 is not particularly limited. The control program can be recorded on a removable recording medium or the control program can be delivered through communication via a network to be installed in the main memory 72 or the auxiliary memory device 13. As long as the recording medium can store a program as in a CD-ROM, a memory card, or the like the device can read the program, any form of the recording medium can be used.

The wireless unit 14 executes wireless communication of data with the access point 70 in conformity with a wireless communication protocol.

The touch panel 15 is a device that serves as both an input device and a display device of the mobile terminal 10. The touch panel 15 detects a touch position on a displayed image and outputs touch position information to the processor 11.

The scanner 16 reads a code symbol such as a two-dimensional data code or a barcode attached to a commodity. The code symbol indicates the commodity code is attached to the commodity. The scanner 16 outputs data of the read code symbol to the processor 11. The scanner 16 may be a type of scanner that reads a code symbol through scanning of laser light or may be a type of scanner that reads a code symbol from an image captured by an imaging device (e.g., a camera).

The reader 17 reads data recorded on a recording medium and outputs the read data to the processor 11. The reader 17 is a magnetic card reader when the recording medium is a magnetic card, and is an integrated circuit (IC) card reader when the recording medium is a contact type IC card. When the recording medium is a recoding medium using a radio frequency identification (RFID) as in a contactless IC card or a smartphone, an RFID reader is used as the reader 17.

The camera 18 is provided on the cart 100 so that a shopping basket 150 placed on a basket receiver 140 of the cart 100 is captured from the upper side. The camera 18 monitors whether a user who is using the cart 100 correctly puts purchase commodities in the shopping basket 150.

In the mobile terminal 10 including the foregoing circuit constituent elements, the processor 11, the main memory 12, the auxiliary memory device 13, the wireless unit 14, and the touch panel 15 are configured by a tablet terminal 110. The scanner 16, the reader 17, and the camera 18 are electrically connected to the tablet terminal 110 to configure the mobile terminal 10.

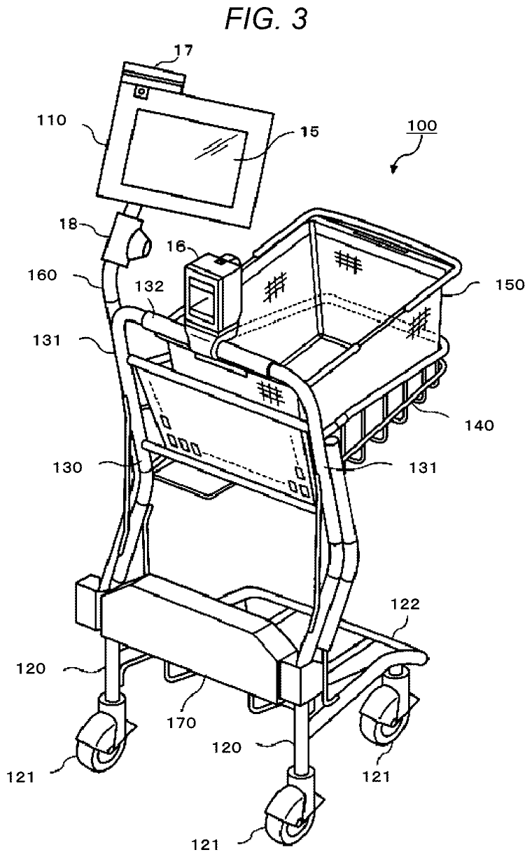

FIG. 3 is a perspective view illustrating an example of a cart 100 provided with the mobile terminal 10. The cart 100 includes a caster portion 120 for movement, a handle frame portion 130, and the basket receiver 140. The caster portion 120 includes four wheels 121 to smoothly move on the surface of a floor. The caster portion 120 includes a support portion 122 on which a large baggage which does not enter the shopping basket 150 is placed. The handle frame portion 130 includes a pair of vertical frames 131 erected on the rear wheel side of the caster portion 120 and a handle bar 132 connecting the upper ends of the vertical frames 131. The basket receiver 140 is in front of a half portion of the handle frame portion 130. In the cart 100, the shopping basket 150 provided in a store can be placed on the basket receiver 140. The shopping basket 150 contains commodities.

The scanner 16 is position proximate the middle of the handle bar 132. The scanner 16 is fitted on the handle bar 132 so that a reading window is located on the front side. The front side is a side on which the user holding the handle bar 132 and pushing the cart 100 stands.

A pole 160 is fitted on one vertical frame 131. A front end of the pole 160 is located above the handle bar 132. The tablet terminal 110 is fitted on the end of the pole 160 so that the screen of the touch panel 15 faces the user. The reader 17 is fitted on the tablet terminal 110 so that a card slit is located on the front side. In FIG. 3, a magnetic card reader is used as the reader 17. The camera 18 is fitted along the pole 160 so that the entire shopping basket 150 placed on the basket receiver 140 can be imaged from above.

The battery 170 is fitted across the vertical frames 131 on the lower end of the handle frame portion 130. The battery 170 is a power source for the tablet terminal 110, the scanner 16, the reader 17, and the camera 18.

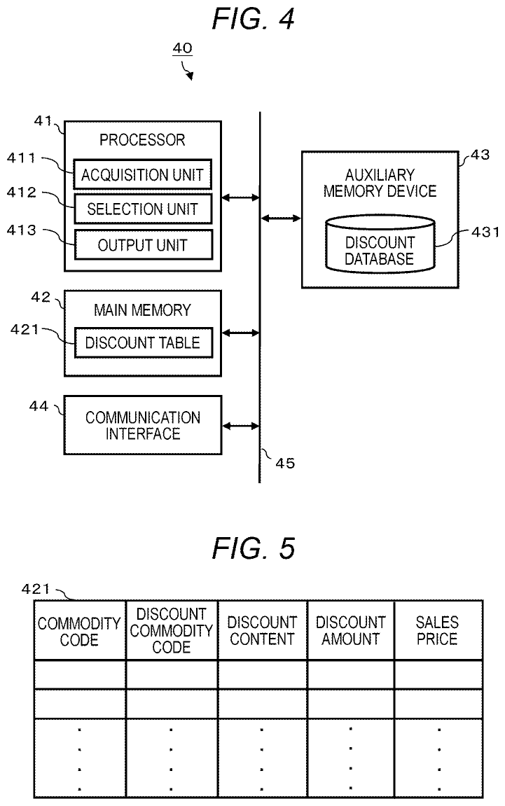

FIG. 4 is a block diagram illustrating a circuit configuration of main units of a discount server 40. The discount server 40 includes a processor 41, a main memory 42, an auxiliary memory device 43, a communication interface 44, and a system transmission path 45. The system transmission path 45 includes an address bus, a data bus, and a control signal line. In the discount server 40, the processor 41, the main memory 42, the auxiliary memory device 43, and the communication interface 44 are connected to the system transmission path 45. In the discount server 40, the processor 41, the main memory 42, and the auxiliary memory device 43, and the system transmission path 45 connecting them to configure a computer.

The processor 41 corresponds to a central unit of the computer. The processor 41 controls each unit such that various functions of the discount server 40 can be realized in accordance with an operating system or an application program. The processor 41 is, for example, a CPU. The processor 41 includes an acquisition unit 411, a selection unit 412, and an output unit 413, which are described in greater detail herein.

The main memory 42 corresponds to a main memory unit of the computer. The main memory 42 includes a nonvolatile memory area and a volatile memory area. The main memory 42 stores the operating system or the application program in the nonvolatile memory area. The main memory 42 stores data necessary for the processor 41 to execute a process of controlling each unit in the nonvolatile memory area or the volatile memory area in some cases. In the main memory 42, the volatile memory area is used as a work area in which data can be rewritten appropriately by the processor 41. The nonvolatile memory area is, for example, a ROM. The volatile memory area is, for example, a RAM.

The auxiliary memory device 43 corresponds to an auxiliary memory unit of the computer. For example, an EEPROM, an HDD, an SSD, or the like can be used as the auxiliary memory device 43. The auxiliary memory device 43 stores data which is used for the processor 41 to execute various processes, data which is generated through a process by the processor 41, and the like. The auxiliary memory device 43 stores the foregoing application program in some cases.

The communication interface 44 is connected to the network 2. The communication interface 44 executes data communication with other devices connected via the network 2 in conformity with a communication protocol.

The discount server 40 that has the configuration uses a part of the volatile memory area of the main memory 42 as a discount table 421.

FIG. 5 is a schematic diagram illustrating an example of the discount table 421. As illustrated in FIG. 5, for each user, the discount table 421 is used to store data related to discount commodities to be applied to the user. The discount table 421 includes a commodity code of a purchase-planned commodity, a discount commodity code, discount content, a discount amount, and a sales price before discount is applied.

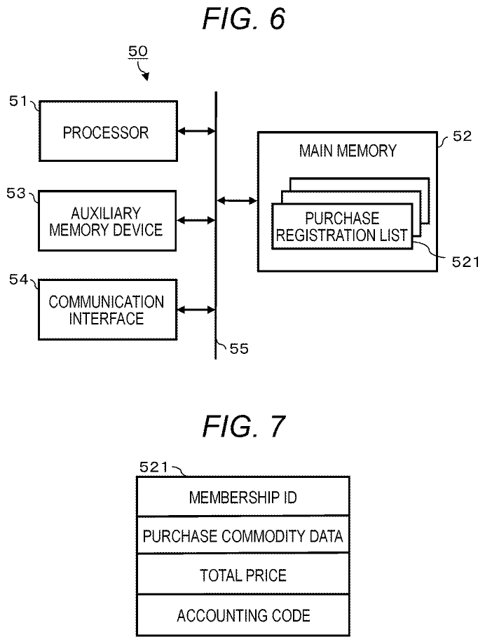

FIG. 6 is a block diagram illustrating a circuit configuration of main units of the virtual POS server 50. The virtual POS server 50 includes a processor 51, a main memory 52, an auxiliary memory device 53, a communication interface 54, and a system transmission path 55. The system transmission path 55 includes an address bus, a data bus, and a control signal line. In the virtual POS server 50, the processor 51, the main memory 52, the auxiliary memory device 53, and the communication interface 54 are connected to the system transmission path 55. In the virtual POS server 50, the processor 51, the main memory 52, and the auxiliary memory device 53, and the system transmission path 55 connecting them to configure a computer.

The processor 51 corresponds to a central unit of the computer. The processor 51 controls each unit such that various functions of the virtual POS server 50 can be realized in accordance with an operating system or an application program. The processor 51 is, for example, a CPU.

The main memory 52 corresponds to a main memory unit of the computer. The main memory 52 includes a nonvolatile memory area and a volatile memory area. The main memory 52 stores the operating system or the application program in the nonvolatile memory area. The main memory 52 stores data necessary for the processor 51 to execute a process of controlling each unit in the nonvolatile memory area or the volatile memory area. In the main memory 52, the volatile memory area is used as a work area in which data can be rewritten appropriately by the processor 51. The nonvolatile memory area is, for example, a ROM. The volatile memory area is, for example, a RAM.

The auxiliary memory device 53 corresponds to an auxiliary memory unit of the computer. For example, an EEPROM, an HDD, an SSD, or the like can be used as the auxiliary memory device 53. The auxiliary memory device 53 stores data which is used for the processor 51 to execute various processes, data which is generated through a process by the processor 51, and the like. The auxiliary memory device 53 stores the foregoing application program in some cases.

The communication interface 54 is connected to the network 2. The communication interface 54 executes data communication with other devices connected via the network 2 in conformity with a communication protocol.

In the virtual POS server 50 that has the configuration, a part of the volatile memory area of the main memory 52 is set as a generation area of a purchase registration list 521. The virtual POS server 50 can generate a plurality of purchase registration lists 521 in the generation area.

FIG. 7 is a schematic diagram illustrating an example of the purchase registration list 521. As illustrated in FIG. 7, the purchase registration list 521 has areas for storing a membership ID, purchase commodity data, a total price, and an accounting code. The accounting code will be described later. The purchase commodity data includes a commodity code, a commodity name, a unit price, the number of purchase commodities, and a purchase price of a purchase commodity which the user purchases. The number of purchase commodities is the number of commodities identified with commodity codes and the purchase price is a price calculated by multiplying the number of commodities by a unit price. The total price is a sum of purchase prices included in the purchase commodity data. The purchase registration list 521 is generated in association with the membership ID of the mobile terminal 10.

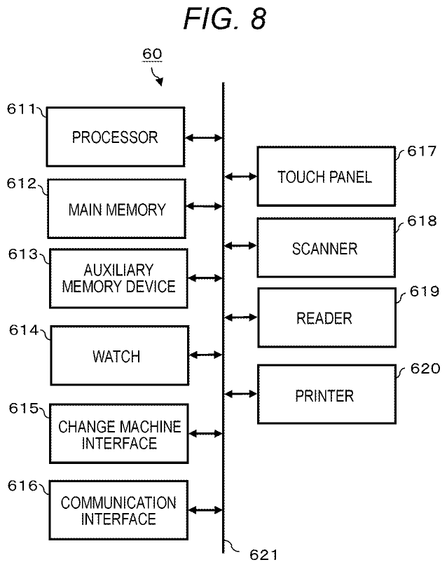

FIG. 8 is a block diagram illustrating a circuit configuration of main units of an accounting machine 60. The accounting machine 60 includes a processor 611, a main memory 612, an auxiliary memory device 613, a watch 614, a change machine interface 615, a communication interface 616, a touch panel 617, a scanner 618, a reader 619, a printer 620, and a system transmission path 621. The system transmission path 621 includes an address bus, a data bus, and a control signal line. The system transmission path 621 connects the processor 611, the main memory 612, the auxiliary memory device 613, the watch 614, the change machine interface 615, the communication interface 616, the touch panel 617, the scanner 618, the reader 619, and the printer 620 to each other. The processor 611, the main memory 612, and the auxiliary memory device 613 are connected to the system transmission path 621 to configure a computer of the accounting machine 60.

The processor 611 corresponds to a central unit of the computer. The processor 611 controls each unit such that various functions of the accounting machine 60 can be realized in accordance with an operating system or an application program. The processor 611 is, for example, a CPU.

The main memory 612 corresponds to a main memory unit of the computer. The main memory 612 includes a nonvolatile memory area and a volatile memory area. The main memory 612 stores the operating system or the application program in the nonvolatile memory area. The main memory 612 stores data necessary for the processor 611 to execute a process of controlling each unit in the nonvolatile memory area or the volatile memory area. In the main memory 612, the volatile memory area is used as a work area in which data can be rewritten appropriately by the processor 611. The nonvolatile memory area is, for example, a ROM. The volatile memory area is, for example, a RAM.

The auxiliary memory device 613 corresponds to an auxiliary memory unit of the computer. For example, an EEPROM, an HDD, an SSD, or the like can be used as the auxiliary memory device 613. The auxiliary memory device 613 stores data which is used for the processor 611 to execute various processes, data which is generated through a process by the processor 611, and the like. The auxiliary memory device 613 stores the foregoing application program in some cases.

Application programs stored in the main memory 612 or the auxiliary memory device 613 include a control program in which information processing executed in the accounting machine 60 is described. A method of installing the control program in the main memory 612 or the auxiliary memory device 613 is not particularly limited. The control program can be recorded on a removable recording medium or the control program can be delivered through communication via a network to be installed in the main memory 612 or the auxiliary memory device 613. As long as recording medium can store a program as in a CD-ROM, a memory card, or the like and the device can read the program, any form of the recording medium can be used.

The watch 614 functions as a time information source of the accounting machine 60. The processor 611 measures a present time and date based on time information measured by the watch 614.

The change machine interface 615 executes data communication with an automatic change machine. The change machine interface 615 receives data of a depositing amount, data of the number of stored coins, and the like from the automatic change machine. The change machine interface 615 transmits change data to the automatic change machine.

The communication interface 616 is connected to the network 2. The communication interface 616 executes data communication with other devices connected to the network 2 in conformity with a communication protocol.

The touch panel 617 is a device that serves as both an input device and a display device of the accounting machine 60. The touch panel 617 detects a touch position on a displayed image and outputs positional information regarding the touch position to the processor 611.

The scanner 618 is an example of a reading device that reads a code symbol such as a barcode or a 2-dimensional code. The scanner 618 may be a type of scanner that reads a code symbol through scanning of laser light or may be a type of scanner that reads a code symbol from an image captured by an imaging device (e.g., a camera).

The reader 619 reads data recorded on a recording medium and outputs the read data to the processor 611. The reader 619 is a magnetic card reader when the recording medium is a magnetic card, and is an IC card reader when the recording medium is a contact type IC card. When the recording medium is a recoding medium using an RFID as in a contactless IC card or a smartphone, an RFID reader is used as the reader 619.

The printer 620 issues a receipt by printing various character strings, images, or the like on a receipt sheet. As such a kind of printer 620, for example, a thermal printer, a dot impact printer, or the like can be used. The printer 620 functions as a printing device of the accounting machine 60.

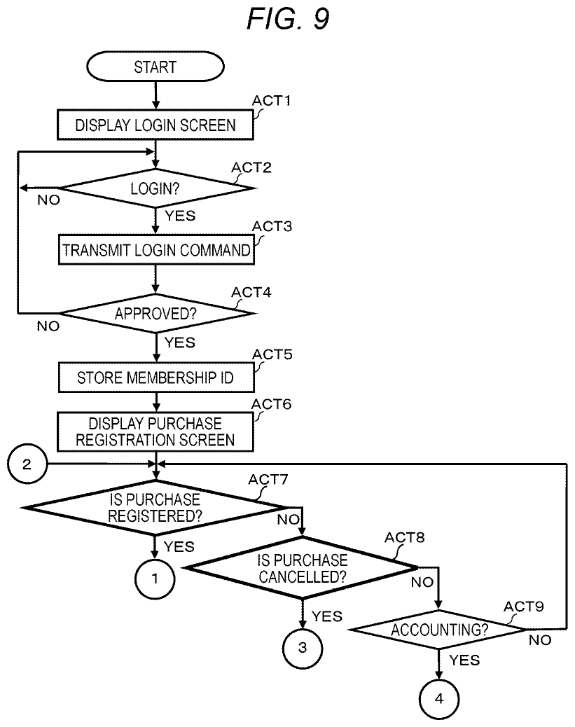

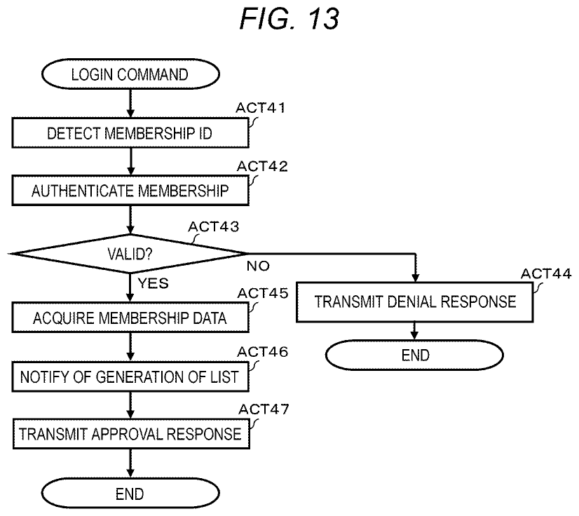

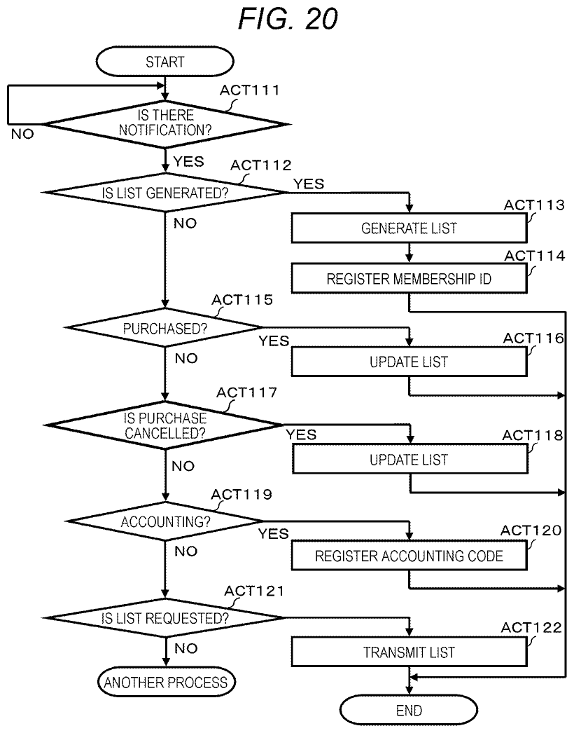

FIGS. 9 to 12 are flowcharts illustrating a control procedure of the processor 11 in the mobile terminal 10. FIGS. 13 to 18 are flowcharts illustrating a control procedure of the processor 41 in the discount server 40. FIG. 19 is a flowchart illustrating a control procedure of the processor 61 in the accounting machine 60. FIG. 20 is a flowchart illustrating a control procedure of the processor 51 in the virtual POS server 50.

Hereinafter, main operations of the information processing system 1 used for a user who is a member to execute registration to settlement of purchase commodities by themselves using the mobile terminal 10 of the cart 100 will be described with reference to the flowcharts. The operations to be described below are exemplary. When the same results are obtained, the procedures are not particularly limited.

First, a user who does shopping using the cart 100 touches the touch panel 15. When the user touches the touch panel 15, the processor 11 in an idle state is activated. The processor 11 starts information processing in the procedure in the flowchart of FIG. 9.

In ACT1, the processor 11 displays a login screen on the touch panel 15. The login screen is a screen for instructing the member to execute a login operation. The user who is the member carries a membership card on which a membership code of the user is recorded. The user who checks the login screen is allowed to read the data of the membership card with the reader 17. When the data of the membership card is read with the reader 17, the data of the membership card is given to the processor 11.

In ACT2, the processor 11 displaying the login screen awaits login. When the processor 11 receives data from the reader 17 and checks that the data is data of the membership card including a membership ID, the processor 11 determines that the login has been executed. That is, the processor 11 determines YES in ACT2, and then the process proceeds to ACT3.

In ACT3, the processor 11 controls the wireless unit 14 such that a login command is transmitted to the discount sever 40. The wireless unit 14 wirelessly transmits the login command under this control. The login command is received by the access point 70 and is transmitted to the discount server 40 via the network 2. The login command includes the membership ID of the membership card read with the reader 17.

The processor 41 of the discount server 40 checks a kind of command when the command is received from the mobile terminal 10 via the communication interface 44. When the received command is the login command, the processor 41 starts a command reception process in the procedure indicating the flowchart of FIG. 13.

In ACT41, the processor 41 detects the membership ID from the login command. In ACT42, the processor 41 authenticates the member identified with the membership ID. Specifically, the processor 41 inquires with the membership server 30 about whether there is the membership data record including the membership ID in the membership database. As a result, when a response is received from the membership server 30 indicating that there is corresponding membership data record in the membership database, the processor 41 determines that membership authentication is valid. Thus, when a response is received from the membership server 30 indicating that there is no corresponding membership data record in the membership database, the processor 41 determines that the membership authentication is invalid.

In ACT43, the processor 41 checks a result of the membership authentication. Here, when the authentication result is invalid, the processor 41 determines NO in ACT43, and then the process proceeds to ACT44. In ACT44, the processor 41 controls the communication interface 44 such that a denial response command is transmitted to the mobile terminal 10. The denial response command is transmitted via the communication interface 44 under this control. The denial response command is wirelessly transmitted from the access point 70 via the network 2 and is received by the mobile terminal 10 which is the login command transmission source. Then, the processor 41 ends the process of receiving the login command.

When the authentication result is valid, the processor 41 determines YES in ACT43, and then the process proceeds to ACT45. In ACT45, the processor 41 requests the membership server 30 to transmit membership data of the member identified with the membership ID and acquires the membership data including the membership ID from the membership server 30.

In ACT46, the processor 41 controls the communication interface 44 such that a list generation notification command is transmitted to the virtual POS server 50. The list generation notification command is transmitted via the communication interface 44 under this control. The list generation notification command is received by the virtual POS server 50 via the network 2. The list generation notification command includes the membership ID.

In ACT111 of FIG. 20, the processor 51 of the virtual POS server 50 awaits a notification command. When the notification command is received via the communication interface 54, the processor 51 determines YES in ACT111, and then the process proceeds to ACT112. In ACT112, the processor 51 checks whether the notification command received in ACT112 is the list generation notification command. In this case, when the list generation notification command is received, the processor 51 determines YES in ACT112, and then the process proceeds to ACT113.

In ACT113, the processor 51 generates a purchase registration list 521 in the main memory 52. In ACT114, the processor 51 registers the membership ID included in the list generation notification command in the purchase registration list 521. Then, the processor 51 ends the information processing in the procedure in the flowchart of FIG. 20.

FIG. 13 is referred back for description. In ACT47, the processor 41 of the discount server 40 controlling the transmission of the list generation notification command in ACT46 controls the communication interface 44 such that an approval response command is transmitted to the mobile terminal 10. The approval response command is transmitted via the communication interface 44 under this control. The approval response command is wirelessly transmitted from the access point 70 via the network 2 and is received by the mobile terminal 10 which is the login command transmission source. Then, the processor 41 ends the process of receiving the login command.

FIG. 9 is referred back for description. In ACT4, the processor 11 of the mobile terminal 10 controlling the transmission of the login command in ACT3 awaits a response command from the discount server 40. When a denial response command is received from the discount server 40, the processor 11 determines NO in ACT4, and the process returns to ACT2. Accordingly, the user executes login again.

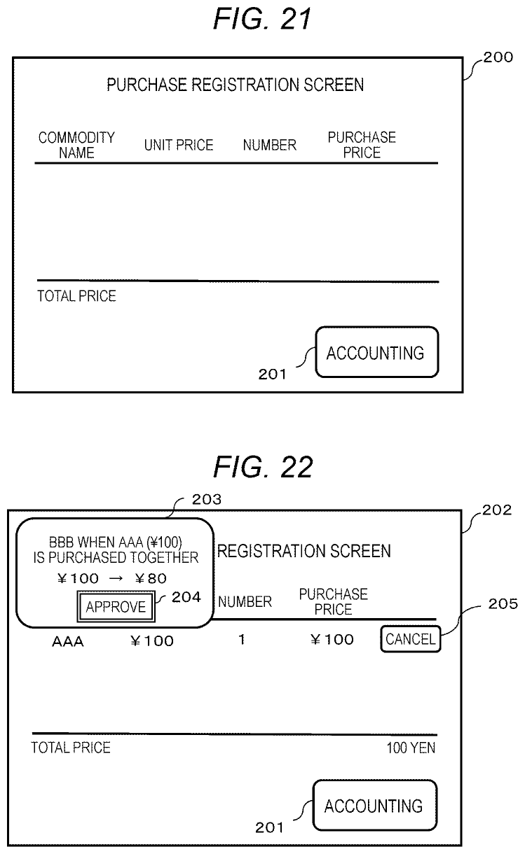

When the approval response command is received from the discount server 40, the processor 11 determines YES in ACT4, and then the process proceeds to ACT5. In ACT5, the processor 11 stores the membership ID included in the approval response command in the main memory 12. In ACT6, the processor 11 displays a purchase registration screen 200 (see FIG. 21) on the touch panel 15.

FIG. 21 is a schematic diagram illustrating an example of the purchase registration screen 200. As illustrated in FIG. 21, an area for displaying a commodity name, a unit price, the number, a purchase price, and a total price of purchased and registered commodities is formed on the purchase registration screen 200. An image of an accounting button 201 for giving an instruction for accounting is displayed.

The user checking the purchase registration screen 200 goes around a store and contains purchase commodities in the cart 100. For example, the user stocks the purchase commodities in the shopping basket 150 placed on the basket receiver 140. Before the user stocks the purchase commodities in the shopping basket 150, the user operates the scanner 16 to read code symbols attached to the purchase commodities. When the code symbols are read with the scanner 16, commodity codes expressed by the code symbols are input to the mobile terminal 10. That is, the commodities identified with the commodity codes are registered.

Code symbols are not attached to some commodities such as fresh food. Although not illustrated, when code symbols are not attached to the purchase commodities, the user touches commodity buttons corresponding to the purchase commodities from the commodity buttons displayed on the screen of the touch panel 15. When the commodity buttons are touched, the commodity codes of the commodities corresponding to the commodity buttons are input to the mobile terminal 10. That is, the commodities identified with the commodity codes are registered. As another method, for example, code symbols such as barcodes or two-dimensional codes may be provided near a price table disposed near commodities such as fruits and vegetables and the code symbols may be read with the scanner 16.

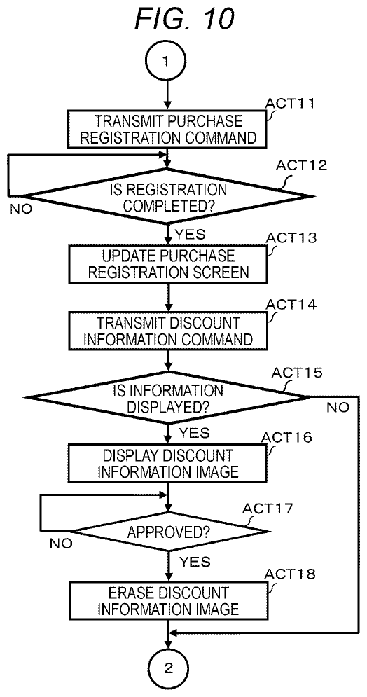

FIG. 9 is referred back for description. When the processes of ACT5 and ACT6 are ended, the processor 11 checks in ACT7 whether purchase is registered. When it is determined that a purchase is registered, the processor 11 determines YES in ACT7, and then the process proceeds to ACT11 of FIG. 10.

In ACT11, the processor 11 controls the wireless unit 14 such that a purchase registration command is transmitted to the discount server 40. The wireless unit 14 wirelessly transmits the purchase registration command under this control. The purchase registration command is received by the access point 70 and is transmitted to the discount server 40 via the network 2. The purchase registration command includes the membership ID and the commodity codes of the purchase commodities stored in the main memory 12.

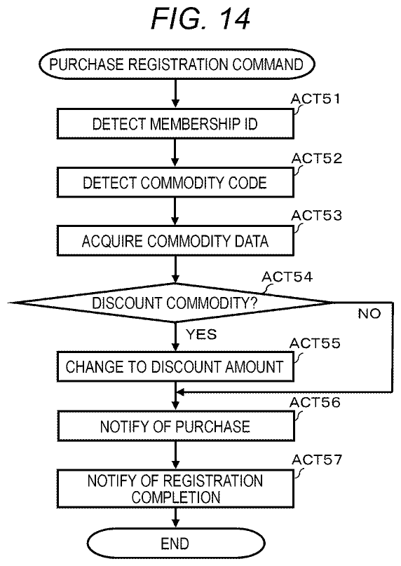

The processor 41 of the discount server 40 receiving the purchase registration command starts a command reception process of a procedure in the flowchart of FIG. 14. In ACT51, the processor 41 detects the membership ID from the purchase registration command. In ACT52, the processor 41 detects the commodity codes of the purchase commodities from the purchase registration command.

In ACT53, the processor 41 inquires about commodity data with the store server 20 using the commodity codes. In response to the inquiry, the store server 20 retrieves the commodity database, reads commodity data of the commodity code, the commodity names, the unit prices, and the discount commodity code from the commodity data record including the commodity code, and responds to the discount server 40. However, the processor 41 acquires the commodity data.

In ACT54, the processor 41 checks whether the commodity is a discount commodity. Specifically, the processor 41 retrieves the discount table 421. When the commodity code acquired in the process of ACT52 are stored as the discount commodity code, the processor 41 checks that the commodity is the discount commodity. When the commodity code is not stored as the discount commodity code, that is, the commodity is not the discount commodity, the processor 41 determines NO in ACT54, and then the process proceeds to ACT56. The process of ACT56 will be described later.

When the commodity is the discount commodity, the processor 41 determines YES in ACT54, and then the process proceeds to ACT55. In ACT55, the processor 41 extracts a discount amount associated with the discount commodity code from the discount table 421. Then, the processor 41 changes the unit price included in the commodity data acquired in the process of ACT53 to the discount amount or adds the discount amount to the commodity data.

In ACT56, the processor 41 controls the communication interface 44 such that the virtual POS server 50 is notified of the purchase. A purchase notification command for purchase notification is transmitted via the communication interface 44 under this control. The purchase notification command is received by the virtual POS server 50 via the network 2. The purchase notification command includes the membership ID and the purchase data of the purchase commodities.

The processor 51 of the virtual POS server 50 detects that the notification command is received in ACT111 of FIG. 20. When it is checked in ACT112 that the notification command is not the list generation notification command, the processor 51 determines NO, and then the process proceeds to ACT115. In ACT115, the processor 51 checks whether the notification command is the purchase notification command. In this case, since the purchase notification command is received, the processor 51 determines YES in ACT115, and then the process proceeds to ACT116. In ACT116, the processor 51 updates the purchase registration list 521. Specifically, the processor 51 registers the purchase commodity data in the registered purchase registration list 521 in which the membership ID included in the purchase notification command is registered based on the commodity data included in the purchase notification command. The processor 51 updates the total price of the purchase registration list 521 to a price obtained by adding the purchase price of newly registered purchase commodity data. Then, the processor 51 ends the information processing of the procedure in the flowchart of FIG. 20.

FIG. 14 is referred back for description. In ACT57, the processor 41 of the discount server 40 controlling the transmission of the purchase notification command in ACT56 controls the communication interface 44 such that a registered notification command is transmitted to the mobile terminal 10. The registered notification command is transmitted via the communication interface 44 under this control. The registered notification command is wirelessly transmitted from the access point 70 via the network 2 and is transmitted to the mobile terminal 10 which is a purchase registration command transmission source. The registered notification command includes the membership ID and the commodity data of the purchase commodities. Then, the processor 41 ends the process of receiving the purchase registration command.

FIG. 10 is referred back for description. In ACT12, the processor 11 of the mobile terminal 10 controlling the transmission of the purchase registration command in ACT11 awaits the registered notification command from the discount server 40. When the registered notification command is received from the discount server 40, the processor 11 determines YES in ACT12, and then the process proceeds to ACT13.

In ACT13, the processor 11 updates the purchase registration screen 200. That is, the processor 11 updates the purchase registration screen 200 so that the commodity names, the unit prices, the total price, and the number of purchased and registered commodities are added and the purchase price is added to the total price.

In ACT14, the processor 11 controls the wireless unit 14 such that a discount information command is transmitted to the discount server 40. The wireless unit 14 wirelessly transmits the discount information command under this control. The discount information command is received by the access point 70 and is transmitted to the discount server 40 via the network 2. The discount information command includes the membership ID stored in the main memory 12 and commodity data of the purchase commodities included in the registered notification command.

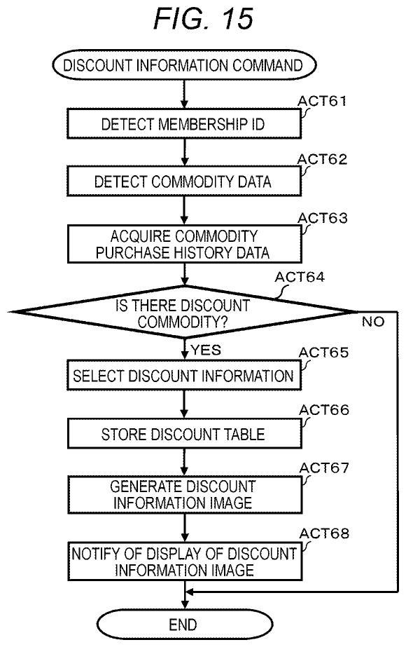

The processor 41 of the discount server 40 receiving the discount information command starts a command reception process of the procedure in the flowchart of FIG. 15. In ACT61, the processor 41 detects the membership ID from the discount information command. In ACT62, the processor 41 detects the commodity data of the purchase commodities from the discount information command.

In ACT63, the processor 41 inquires about the commodity purchase history data with the membership server 30 using the membership ID. In response to the inquiry, the membership server 30 retrieves the membership database, reads the commodity purchase history data identified with the membership ID, and responds to the discount server 40. However, the processor 41 acquires the commodity purchase history data.

In ACT64, based on the commodity purchase history data, the processor 41 checks whether the discount commodity can be combined with the commodity. Specifically, the processor 41 determines that there is the discount commodity when the discount commodity code is set in the commodity data acquired in the process of ACT62 and the discount commodity code is included in the commodity purchase history data acquired in the process of ACT63. For example, the processor 41 determines that there is discount commodity B to which discount is applied in combination with commodity A when discount commodity B is set in commodity A and the user purchases one or more commodities B within a previous fixed period based on the commodity purchase history data. Alternatively, the processor 41 determines that there is discount commodity B to which discount is applied in combination with commodity A when the user purchases commodity A and the commodity B on the same day within the previous fixed period based on the commodity purchase history data. When a null value is set as the discount commodity code, that is, there is no discount commodity, the processor 41 determines NO in ACT64 and ends the process of receiving the discount information command.

When there is the discount commodity, the processor 41 determines YES in ACT64, and then the process proceeds to ACT65. In ACT65, the processor 41 selects discount information, that is, discount content, a discount amount, and a sales price, from the discount database 431.

In ACT66, the processor 41 stores the commodity code, the discount commodity code, the discount content, the discount amount, and the sales price in the discount table 421.

In ACT67, the processor 41 generates a discount information image 203 (see FIG. 22) based on the data of the discount table 421.

FIG. 22 is a schematic diagram illustrating an example of the discount information image 203. As illustrated in FIG. 22, the discount information image 203 is overlapped and displayed on a purchase registration screen 202. In the discount information image 203, text data for displaying discount information is displayed along with an image of a check button 204. The check button 204 is touched when the user approves the discount information. Content of the text data displayed in FIG. 22 is exemplary. The content may notify the user of the discount information. An image of each cancellation button 205 is displayed in the purchased and registered commodity data. The cancellation button 205 is touched by the user when the user wants to stop purchasing the corresponding purchased and registered commodities. When the cancellation button 205 is touched, it is recognized that an instruction to cancel the commodity corresponding to the cancellation button 205 is given.

FIG. 15 is referred back for description. In ACT68, the processor 41 controls the communication interface 44 such that the discount information image 203 is overlapped and displayed on the purchase registration screen 202 in the mobile terminal 10. An information display command for notifying of display of the discount information image 203 is transmitted via the communication interface 44 under this control. The information display command is wirelessly transmitted from the access point 70 via the network 2 and is received by the motile terminal 10 which is a discount information command transmission source. Then, the processor 41 ends the process of receiving the discount information command.

FIG. 10 is referred back for description. In ACT15, the processor 11 of the mobile terminal 10 controlling the transmission of the discount information command in ACT14 awaits the information display command from the discount server 40. When the information display command is not received from the discount server 40, the processor 11 determines NO in ACT15, and then the process returns to ACT7 of FIG. 9.

When the information display command is received, the processor 11 determines YES in ACT15, and then the process proceeds to ACT16. In ACT16, the processor 11 overlaps and displays the discount information image 203 on the purchase registration screen 202.

The processor 11 controlling the display of the discount information image 203 awaits in ACT17 whether the check button 204 is touched. When the check button 204 is touched, the processor 11 determines YES in ACT17, and then the process proceeds to ACT18.

In ACT18, the processor 11 erases the discount information image 203 from the purchase registration screen 202, and then the process returns to ACT7 of FIG. 9.

Incidentally, when the purchase is not registered, the processor 11 determines NO in ACT7, and then the process proceeds to ACT8. In ACT8, the processor 11 checks whether the purchase is cancelled. That is, the processor 11 checks whether the cancellation button 205 of the purchase registration screen 202 is touched.

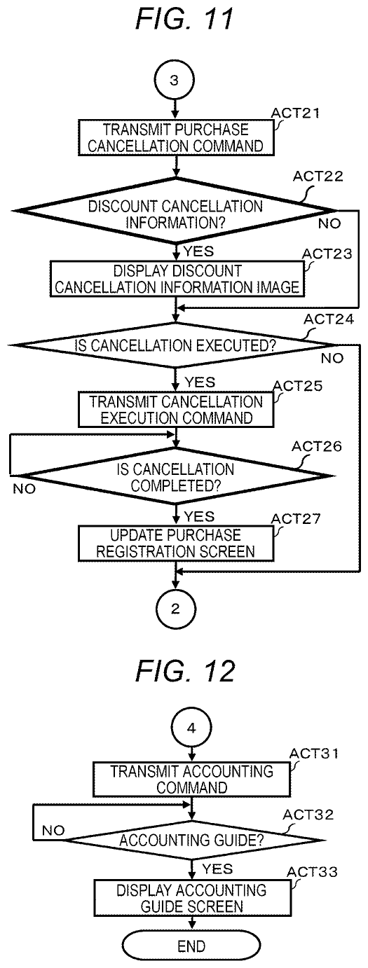

When it is checked that the cancellation button 205 is touched, the processor 11 determines YES in ACT8, and then the process proceeds to ACT21 of FIG. 11. In ACT21, the processor 11 controls the wireless unit 14 such that a purchase cancellation command is transmitted to the discount server 40. The wireless unit 14 wirelessly transmits the purchase cancellation command under this control. The purchase cancellation command is received by the access point 70 and is transmitted to the discount server 40 via the network 2. The purchase cancellation command includes the membership ID stored in the main memory 12 and a commodity code of the purchase commodity corresponding to the cancellation button 205.

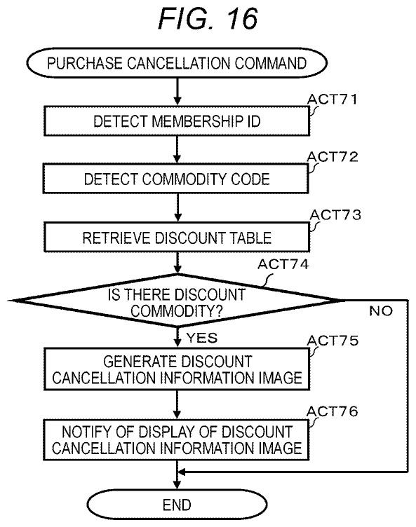

The processor 41 of the discount server 40 receiving the purchase cancellation command starts a process of receiving a command of a procedure in the flowchart of FIG. 16.

In step S71, the processor 41 detects the membership ID from the purchase cancellation command. In ACT72, the processor 41 detects the commodity code of the purchase commodity from the purchase cancellation command.

In ACT73, the processor 41 retrieves the discount table 421. In ACT74, the processor 41 checks whether the discount commodity code associated with the commodity code is stored in the discount table 421. When the discount commodity code is not stored, the processor 41 determines NO in ACT74 and ends the process of receiving the purchase cancellation command.

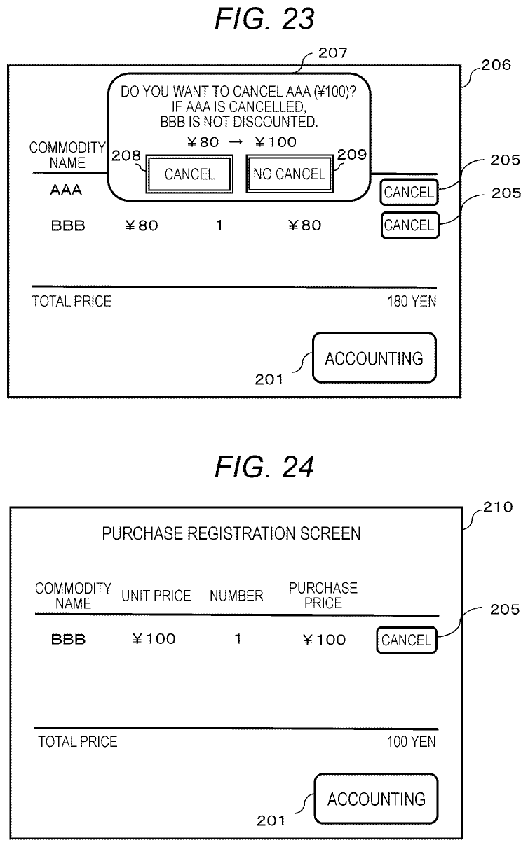

When the discount commodity code is stored, the processor 41 determines YES in ACT74, and then the process proceeds to ACT75. In ACT75, the processor 41 generates a discount cancellation information image 207 (see FIG. 23) based on data of the discount table 421.

FIG. 23 is a schematic diagram illustrating an example of the discount cancellation information image 207. As illustrated in FIG. 23, the discount cancellation information image 207 is overlapped and displayed on the purchase registration screen 206. In the discount cancellation information image 207, a message inquiring about purchase cancellation of the commodity and text data displaying discount cancellation information is displayed along with images of a “Cancel” button 208 and “No cancel” button 209. The “Cancel” button 208 is touched when the user cancels the purchase of the commodity. The “No cancel” button 209 is touched when the user does not cancel the purchase of the commodity. The content of the text data displayed in FIG. 23 is exemplary. The user may be notified of the content for notifying the user of the discount cancellation information.

FIG. 16 is referred back for description. In ACT76, the processor 41 controls the communication interface 44 such that the discount cancellation information image 207 is overlapped and displayed on the purchase registration screen 206 in the mobile terminal 10. A cancellation display command for notifying the display of the discount cancellation information image 207 is transmitted via the communication interface 44 under this control. The cancellation display command is wirelessly transmitted from the access point 70 via the network 2 and is received by the mobile terminal 10 which is a purchase cancellation command transmission source. Then, the processor 41 ends the process of receiving the purchase cancellation command.

FIG. 11 is referred back for description. In ACT22, the processor 11 of the mobile terminal 10 controlling the transmission of the purchase cancellation command in ACT21 awaits a cancellation display command from the discount server 40. When the cancellation display command is not received from the discount server 40, the processor 11 determines NO in ACT22, and then the process proceeds to ACT24. The process of ACT24 will be described later.

When the cancellation display command is received, the processor 11 determines YES in ACT22, and then the process proceeds to ACT23. In ACT23, the processor 11 overlaps and displays the discount cancellation information image 207 on the purchase registration screen 206.

In ACT24, the processor 11 awaits whether the “Cancel” button 208 or the “No cancel” button 209 is touched. When the processor 11 determines NO in ACT22 and the process proceeds to ACT24, text data for displaying the discount cancellation information is not displayed in the discount cancellation information image 207. In this case, although not illustrated, for example, a message for inquiring about purchase cancellation of the commodity is overlapped and displayed on the purchase registration screen 206 along with the images of the “Cancel” button 208 and the “No cancel” button 209. When the “No cancel” button 209 is touched, the processor 11 determines NO in ACT24, and then the process returns to ACT7 of FIG. 9.

When the “Cancel” button 208 is touched, the processor 11 determines YES in ACT24, and then the process proceeds to ACT25.

In ACT25, the processor 11 controls the wireless unit 14 such that a cancellation execution command is transmitted to the discount server 40. The wireless unit 14 wirelessly transmits the cancellation execution command under this control. The cancellation execution command is received by the access point 70 and is transmitted to the discount server 40 via the network 2. The membership ID stored in the main memory 12 and the commodity code of the purchase commodity corresponding to the cancellation button 205 are included.

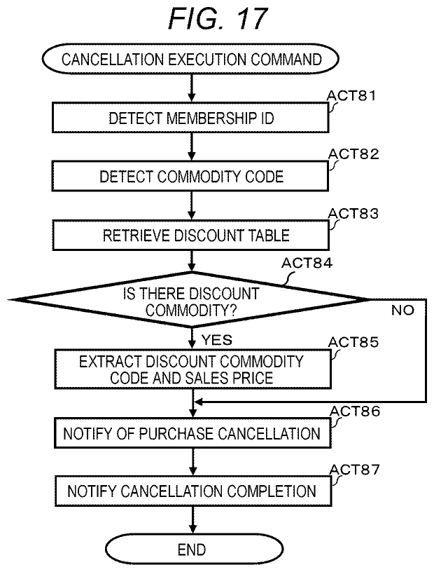

The processor 41 of the discount server 40 receiving the cancellation execution command starts a process of receiving a command of the procedure in the flowchart of FIG. 17. In ACT81, the processor 41 detects the membership ID from the cancellation execution command. In ACT82, the processor 41 detects the commodity code of the purchase commodity from the cancellation execution command.

In ACT83, the processor 41 retrieves the discount table 421. In ACT84, the processor 41 checks whether the discount commodity code associated with the commodity code is stored in the discount table 421. When the discount commodity code is not stored, the processor 41 determines NO in ACT84, and then the process proceeds to ACT86. The process of ACT86 will be described later.

When the discount commodity code is stored, the processor 41 determines YES in ACT84, and then the process proceeds to ACT85. In ACT85, the processor 41 extracts the discount commodity code and a sales price associated with the discount commodity code from the discount table 421.

In ACT86, the processor 41 controls the communication interface 44 such that the virtual POS server 50 is notified of the purchase cancellation. A purchase cancellation notification command for notifying of the purchase cancellation is transmitted via the communication interface 44 under this control. The purchase cancellation notification command is received by the virtual POS server 50 via the network 2. When the processor 41 determines NO in ACT84 and the process proceeds to ACT86, the purchase cancellation notification command includes the membership ID and the commodity code of the purchase commodity. When the processor 41 ends the process of ACT85 and the process proceeds to ACT86, the purchase cancellation notification command includes the membership ID, the commodity code of the purchase commodity, and the discount commodity and the sales price acquired in the process of ACT85.

When it is detected in ACT111 of FIG. 20 that the notification command is received and it is checked in ACT115 that the notification command is not the purchase notification command, the processor 51 of the virtual POS server 50 determines NO, and then the process proceeds to ACT117. In ACT117, the processor 51 checks whether the notification command is the purchase cancellation notification command. In this case, since the purchase cancellation notification command is received, the processor 51 determines YES in ACT117, and then the process proceeds to ACT118. In ACT118, the processor 51 updates the purchase registration list 521. Specifically, the processor 51 erases the purchase commodity data associated with the commodity code included in the purchase notification command from the purchase registration list 521 in which the membership ID included in the purchase cancellation notification command is registered. When the purchase notification command includes the discount commodity code and the sales price, the processor 51 changes the discount amount of the purchase commodity data in which the discount commodity code is registered as the commodity code, to a sales price. The total price of the purchase registration list 521 is updated based on the purchase price of the purchase commodity data newly registered again. Then, the processor 51 ends the information processing of the procedure in the flowchart of FIG. 20.

FIG. 17 is referred back for description. In ACT87, the processor 41 of the discount server 40 controlling the transmission of the purchase cancellation notification command in ACT86 controls the communication interface 44 such that a cancelled notification command is transmitted to the mobile terminal 10. The cancelled notification command is transmitted via the communication interface 44 under this control. The cancelled notification command is wirelessly transmitted from the access point 70 via the network 2 and is received by the mobile terminal 10 which is a cancellation execution command transmission source. Then, the processor 41 ends the process of receiving the cancellation execution command.

FIG. 11 is referred back for description. In ACT26, the processor 11 of the mobile terminal 10 controlling the transmission of the cancellation execution command in ACT25 awaits the cancelled notification command from the discount server 40. When the cancelled notification command is received from the discount server 40, the processor 11 determines YES in ACT26, and then the process proceeds to ACT27. In ACT27, the processor 11 updates a purchase registration screen 210 (see FIG. 24), and then the process returns to ACT7 of FIG. 9.

FIG. 24 is a schematic diagram illustrating an example of the purchase registration screen 210 updated after the purchase cancellation. As illustrated in FIG. 24, the commodity data of which the purchase and registration are cancelled is erased and the sales price before application of the discount is displayed for the commodity to which the discount is applied in combination of the commodity.

FIG. 9 is referred back for description. When the purchase is not cancelled, the processor 11 determines NO in ACT8, and then the process proceeds to ACT9. In ACT9, the processor 11 checks whether an instruction for accounting is given.

An image of an accounting button 201 is displayed in a part of the purchase registration screen 210. The user who has finished the purchase touches the accounting button 201. When the accounting button 201 is touched, the processor 11 recognizes that the instruction for accounting is given. When the instruction for accounting is not given, the processor 11 determines NO in ACT9, and then the process returns to ACT7.

When it is determined that the instruction for accounting is given, the processor 11 determines YES in ACT9, and then the process proceeds to ACT31 of FIG. 12. In ACT31, the processor 11 controls the wireless unit 14 such that an accounting command is transmitted to the discount server 40. The wireless unit 14 wirelessly transmits the accounting command under this control. The accounting command is received by the access point 70 and is transmitted to the discount server 40 via the network 2. The accounting command includes the membership ID stored in the main memory 12.

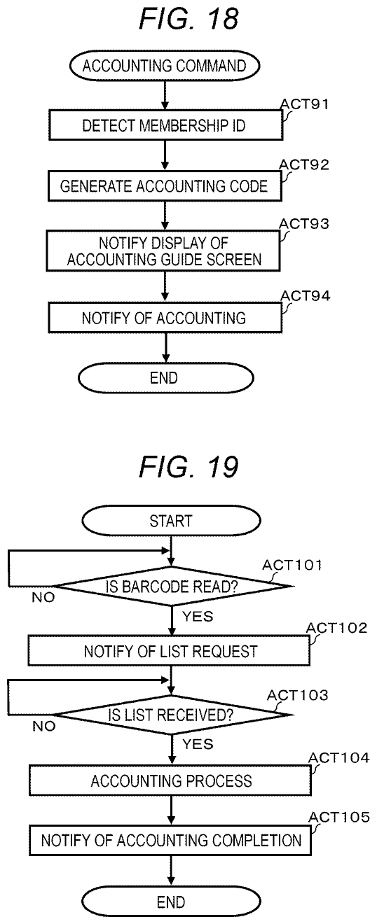

The processor 41 of the discount server 40 receiving the accounting command starts a command reception process of the procedure in the flowchart of FIG. 18. In ACT91, the processor 41 detects the membership ID from the accounting command. In ACT92, the processor 41 generates data of an accounting code. The accounting code is used to identify the user who executes accounting with the accounting machine 60. The accounting code is generated for each user who executes accounting with the accounting machine 60.

In ACT93, the processor 41 controls the communication interface 44 such that an accounting guide screen is displayed on the mobile terminal 10. A guide display command for notifying of display of the accounting guide screen is transmitted via the communication interface 44 under this control. The guide display command is wirelessly transmitted from the access point 70 via the network 2 and is received by the mobile terminal 10 which is an accounting command transmission source. The guide display command includes image data of an accounting barcode indicating an accounting code generated in ACT92.

FIG. 12 is referred back for description. In ACT32, the processor 11 of the mobile terminal 10 controlling the transmission of the accounting command in ACT31 checks whether the guide display command is received from the discount server 40. When the guide display command is received, the processor 11 determines YES in ACT32, and then the process proceeds to ACT33. In ACT33, the processor 11 displays the accounting guide screen on the touch panel 15. An image of an accounting barcode is displayed on the accounting guide screen. Then, the processor 71 ends the information processing of the procedure in the flowchart of FIG. 12.

FIG. 18 is referred back for description. In ACT94, the processor 41 of the discount server 40 controlling the transmission of the guide display command in ACT93 controls the communication interface 44 such that the accounting notification command is transmitted to the virtual POS server 50. The accounting notification command is transmitted via the communication interface 44 under this control. The accounting notification command is received by the virtual POS server 50 via the network 2. The accounting notification command includes the membership ID and the accounting code. Then, the processor 41 ends the process of receiving the accounting command.

When it is detected in ACT111 of FIG. 20 that the notification command is received and it is checked in ACT117 that the notification command is not the purchase cancellation notification command, the processor 51 of the virtual POS server 50 determines NO, and then the process proceeds to ACT119. In ACT119, the processor 51 checks whether the notification command is not the accounting notification command. In this case, since the accounting notification command is received, the processor 51 determines YES in ACT119, and the process proceeds to ACT120. In ACT120, the processor 51 registers the accounting code included in the accounting notification command in the purchase registration list 521 in which the membership ID included in the accounting notification command is registered. Then, the processor 51 ends the information processing of the procedure in the flowchart of FIG. 20.

The user checking the accounting guide screen goes to an accounting place and uses the scanner 618 of the accounting machine 60 to read accounting barcodes displayed on the accounting guide screen.

In ACT101 of FIG. 19, the processor 611 of the accounting machine 60 checks whether the accounting barcodes are read. When the accounting barcodes are read, the processor 611 determines YES in ACT101, and then the process proceeds to ACT102.

In ACT102, the processor 611 controls the communication interface 616 so that a list request command is transmitted to the virtual POS server 50. The communication interface 616 transmits the list request command under this control. The list request command is received by the virtual POS server 50 via the network 2. The list request command includes an accounting code obtained by analyzing the accounting barcodes.

When it is detected in ACT111 of FIG. 20 that the notification command is received and it is checked in ACT119 that the notification command is not the accounting notification command, the processor 41 of the virtual POS server 50 determines NO, and then the process proceeds to ACT121. In ACT121, the processor 41 checks whether the notification command is a list request notification command. In this case, since the list request notification command is received, the processor 41 determines YES in ACT121, and then the process proceeds to ACT122. In ACT122, the processor 41 transmits data of the purchase registration list 521 in which the accounting code is registered included in the list request notification command is registered, to the accounting machine 60. Then, the processor 51 ends the information processing of the procedure in the flowchart of FIG. 20.

FIG. 19 is referred back for description. In ACT103, the processor 611 of the accounting machine 60 controlling the transmission of the list request notification command awaits the data of the purchase registration list 521. When the data of the purchase registration list 521 is received from the virtual POS server 50, the processor 611 determines YES in ACT103, and then the process proceeds to ACT104. The processor 611 executes the accounting process based on the data of the purchase registration list 521 received in ACT104. Since the accounting process is known, specific description will be omitted. Then, the processor 611 transmits an accounting completion command to the discount server 40. The accounting completion command includes the data of the purchase registration list 521 including the membership ID registered in the purchase registration list 521. Then, the processor 611 ends the information processing of the procedure in the flowchart of FIG. 19.

The processor 41 of the discount server 40 receiving the accounting completion command adds the data of the purchase registration list 521 included in the accounting completion command to the commodity purchase history data of the membership database identified with the membership ID included in the accounting completion command.

As apparent from the foregoing description, the discount server 40 which is an example of an information processing device configures the acquisition unit 411 by causing the processor 41 to execute the processes of ACT51 to ACT53 of FIG. 14 and ACT61 to ACT63 of FIG. 15. That is, the discount server 40 acquires a commodity purchase history and a first commodity, that is, first commodity registration information indicating a purchase schedule of the purchase commodities.

The discount server 40 configures the selection unit 412 by causing the processor 41 to execute the process of ACT65 of FIG. 15. That is, the discount server 40 selects a second commodity to which discount is applied in combination with the purchase commodities, that is, discount information regarding a discount commodity, based on the commodity purchase history.

Further, the discount server 40 configures the output unit 413 by causing the processor 41 to execute the processes of ACT67 and ACT68 of FIG. 15. That is, the discount server 40 outputs the discount information regarding the discount commodity.

In the information processing system 1 including the information processing device, a combination of the purchase commodities can be selected for each user based on the commodity purchase history and information regarding the discount commodity can be acquired. Specifically, the membership ID is granted to the user through membership registration executed in advance and the purchase registration in which the cart 100 is used becomes valid. The discount server 40 acquires the commodity purchase history data specified with the membership ID from the membership server 30. The discount server 40 combines the purchase commodities and the discount commodities for each user and outputs the discount information based on the commodity purchase history data. Accordingly, since appropriate discount information can be recommended to an appropriate user, a possibility of commodity purchase increases and efficiency can be achieved.

When the purchase commodity is cancelled, the discount cancellation information is output for the commodity to which the discount is applied in combination with the commodity. Accordingly, the user can ascertain a present correct purchase commodity information. Further, it is possible to prevent illegal purchase of the commodities in advance.

The embodiment of the information processing device, the control program therefor, and the information processing method has been described, but the embodiments are not limited thereto.

In the foregoing embodiment, the case in which the mobile terminal 10 is fitted on the cart 100 has been exemplified. The mobile terminal 10 may not necessarily be fitted on the cart 100. For example, a smartphone, a tablet terminal, or the like carried by the user may be used as the mobile terminal 10.

In the foregoing embodiment, the accounting process executed using the accounting machine 60 has been described. The accounting process may not be executed with the accounting machine 60.

In the foregoing embodiment, the discount information selected based on the commodity purchase history data of the user has been described. The selection of the discount information is not limited to the selection based on the commodity purchase history data. The discount information may be selected based on commodity management information of each store or each store area. For example, discount information regarding commodities dull to sales and identified from the commodity management information can be provided. The discount information may be selected based on the commodity purchase history data of the user and the commodity management information. For example, confectionary (commodities to be sold in carts on sale) of dead stock identified from the commodity management information may be recommended as discount commodities to the user who frequently purchase confectionary identified from the commodity purchase history data or new confectionary.

In the foregoing embodiment, the commodity purchase history data of the user has been described as commodity purchase history data of an individual person identified from the user authentication result. For example, the commodity purchase history data identified from attribute information (sex, age, and the like) associated with the user authentication result, that is, commodity purchase history data not identified for an individual person, may be used. That is, a tendency of commodity purchase (combination) may be analyzed from the commodity purchase history data of a plurality of users and discount information may be selected based on an analysis result. Thus, discount information regarding recommended combined commodities not limited to a history of an individual person can be supplied.

In the foregoing embodiment, the discount information and the discount cancellation information have been exemplified as data in which letters, figures, images, and the like indicating the information are combined. The discount information and the discount cancellation information may be data in which sounds, moving images, and the like are combined.

In the foregoing embodiment, the discount table 421 including the commodity code, the discount commodity code, the discount content, a discount amount, and a sales price has been described. The discount table 421 is not limited to these items. For example, another item such as a discount flag may be added. The discount flag is 1-bit data in which “0” is set in an initial state until the discount commodity is purchased, and “1” is set when the discount commodity is purchased. By setting the discount flag, it is possible to limit the discount application to the same discount information to one. Accordingly, since the same discount information is not displayed several times, it is possible to inhibit the user from feeling troublesome due to repeated display.

In the foregoing embodiment, the discount server 40 has been described as one kind of information processing device. The discount server 40 is not limited to the discount server described in the foregoing embodiment. For example, the discount server 40 that further has a function of at least one server among the store server 20, the membership server 30, and the virtual POS server 50 may be used as an information processing device. In other words, the store server 20, the membership server 30, or the virtual POS server 50 that have the function of the discount server 40 may be used as an information processing device.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An information processing device comprising:
a processor configured to:
acquire first commodity registration information indicating a first purchase registration of a first commodity by a user;
acquire a commodity purchase history of the user;
determine discount information regarding a second commodity to which a discount can be applied in combination with the first commodity based on the commodity purchase history; and
output discount information regarding the second commodity.

2. The information processing device of claim 1, wherein the processor is configured to:
acquire a user authentication result regarding the user;
determine the commodity purchase history of the user in response to the user authentication result indicating the user is authenticated; and
determine the discount information regarding the second commodity based on the commodity purchase history of the user specified from the user authentication result.

3. The information processing device of claim 1, wherein the processor is configured to:
acquire second commodity registration information indicating a second purchase registration of the second commodity;
determine a purchase price of the first commodity and a discount amount of the second commodity based on the first commodity registration information and second commodity registration information; and
output the purchase price of the first commodity and the discount amount of the second commodity.

4. The information processing device of to claim 3, wherein the processor is configured to:
acquire a request for cancellation of the first purchase registration of the first commodity;
determine discount cancellation information regarding the second commodity based on the request for cancellation; and
output the discount cancellation information regarding the second commodity.

5. A commodity registration and discount system comprising:
a mobile terminal including:
a display; and
a scanner configured to read code symbols on commodities; and
a server configured to:
acquire first commodity registration information indicating a first purchase registration of a first commodity based on a first code symbol read by the scanner;
determine discount information regarding a second commodity to which a discount can be applied in combination with the first commodity; and
transmit discount information regarding the second commodity to the mobile terminal.

6. The commodity registration and discount system of claim 5, wherein the server is configured to:
authenticate the customer based on customer information received from the mobile terminal;
acquire a commodity purchase history associated with the customer in response to the customer being authenticated; and
determine the discount information regarding the second commodity to which the discount can be applied in combination with the first commodity based on the commodity purchase history.

7. The commodity registration and discount system of claim 6, wherein the mobile terminal includes a reader configured to acquire the customer information.

8. The commodity registration and discount system of claim 6, wherein the mobile terminal is configured to allow manual entry of the customer information.

9. The commodity registration and discount system of claim 5, wherein the server is configured to:
acquire second commodity registration information indicating a second purchase registration of the second commodity;
determine a purchase price of the first commodity and a discount amount of the second commodity based on the first commodity registration information and second commodity registration information; and
transmit the purchase price of the first commodity and the discount amount of the second commodity to the mobile terminal for display on the display of the mobile terminal.

10. The commodity registration and discount system of to claim 9, wherein the processor is configured to:
acquire a request for cancellation of the first purchase registration of the first commodity;
determine discount cancellation information regarding the second commodity based on the request for cancellation; and
transmit the discount cancellation information regarding the second commodity to the mobile terminal for display on the display of the mobile terminal.

11. The commodity registration and discount system of to claim 10, wherein mobile terminal is configured to display a request for confirmation of cancellation on the display prior to the cancelation being finalized.

12. The commodity registration and discount system of to claim 5, wherein the mobile terminal includes a cart to which the display and the scanner are coupled.

13. An information processing method, the method comprising:
acquiring, by a server, first commodity registration information indicating a first purchase registration of a first commodity;
determining, by the server, discount information regarding a second commodity to which a discount can be applied in combination with the first commodity; and
outputting, by the server, the discount information regarding the second commodity.

14. The method of claim 13, further comprising:
acquiring, by a mobile terminal, the first commodity registration information; and
transmitting, by the mobile terminal, the first commodity registration information to the server.

15. The method of claim 13, further comprising:
acquiring, by a mobile terminal, customer information from a customer using the mobile terminal;
transmitting, by the mobile terminal, the customer information to the server;
acquiring, by the server, a commodity purchase history associated with the customer based on the customer information; and
determining, by the server, the discount information regarding the second commodity to which the discount can be applied in combination with the first commodity based on the commodity purchase history; and
transmitting, by the server, the discount information regarding the second commodity to the mobile terminal.

16. The method of claim 15, wherein the mobile terminal includes a reader configured to acquire the customer information.

17. The method of claim 15, wherein the mobile terminal includes a user interface that facilitates manual entry of the customer information.

18. The method of claim 13, further comprising:
acquiring, by the server, second commodity registration information indicating a second purchase registration of the second commodity;
determining, by the server, a purchase price of the first commodity and a discount amount of the second commodity based on the first commodity registration information and second commodity registration information; and
outputting, by the server, the purchase price of the first commodity and the discount amount of the second commodity.

19. The method of to claim 18, further comprising:
acquiring, by the server, a request for cancellation of the first purchase registration of the first commodity;
determining, by the server, discount cancellation information regarding the second commodity based on the request for cancellation; and
outputting, by the server, the discount cancellation information regarding the second commodity.

20. The method of to claim 19, further comprising receiving, by the server, a confirmation of cancellation of the first purchase registration after outputting the discount cancellation information.
